(19) United States
(12) Patent Application Publication
(10) Pub. No.: US 2014/0094721 A1
(43) Pub. Date: Apr. 3, 2014

(54) Device and Method for Knee Rehabilitation

(71) Applicant: Ibrahima Diallo, Upper Marlboro, MD (US)

(72) Inventor: Ibrahima Diallo, Upper Marlboro, MD (US)

(21) Appl. No.: 13/937,021

(22) Filed: Jul. 8, 2013

Related U.S. Application Data
(60) Provisional application No. 61/706,896, filed on Sep. 28, 2012.

(51) Int. Cl. A61H 1/02

(52) U.S. Cl. CPC A61H 1/024
USPC 601/5; 601/34

(57) ABSTRACT

A device for increasing the range of motion of a patient's knee joint comprising of a longitudinal track frame, having a sitting platform at one end and a movable leg and foot platform at the other end, driven back and forth by a foot actuation mechanism in a flexion-extension motion, linearly along the longitudinal track by an electronically controlled motor in accordance with user defined settings and operable in a passive, active or resistive mode in either a supine or sitting position.

### REFERENCE TO RELATED APPLICATIONS

This Application claims priority to U.S. Provisional Patent Application 61/706,896 filed Sep. 28, 2012, the entire contents of which are incorporated herein by reference.

### FIELD OF THE INVENTION

The invention relates to a device and method for management of an injured or post operative knee and more particularly, a device and method for increasing range-of-motion, strength, and knee function of a patient's joint pre and post operatively.

### BACKGROUND OF THE INVENTION

Persons' with injured knee, post operated knee patients, (total knee arthroplasties, open, mini invasive and arthroscopic ACL/PCL, miniscal, joint and muscle repairs) and payers, seek innovative options for managing knee pain, through therapeutic exercises to rehabilitate soft tissue injuries, degenerative joint conditions, and restore joint ROM, strength, and modulate pain to increase limb function pre and post operatively. Because of the significant costs associated with knee surgeries, lost time from work, and oftentimes extensive rehabilitation period, and rise in health care cost to patients and payers; the need for cost effective mechanical devices that promotes healing, maximum voluntary isometric muscle contraction, range of motion and decrease pain to minimize its debilitative effects on the knee post operatively, promote early return to functional independence and decrease rehab cost cannot be overstated.

Most often, patients' post-surgery or following a traumatic knee injury or having a degenerative joint condition(s) with limiting pain, may result in loss of ROM and function with increase risk of associated co morbidities due to pain and immobility. For example, patients' with chronic knee pain from degenerative joint disease and those who underwent surgery for anterior or posterior cruciate ligament reconstructions, for torn meniscus, femoral and tibia plateau fractures, or other injuries associated with the knee joint or nearby areas of the body often experience some degree of arthrofibrosis (joint stiffness) causing pain, and limited joint ROM, that limits their overall functional independence and quality of life. Indeed, arthrofibrosis is one of the leading complications of knee surgery and a cause in knee stiffness and pain. This undesirable condition results from the formation of extensive, internal scar tissue from lack of movement, inflammation and poor arthrokinematics in the patient's knee joint. Arthrofibrosis may involve the loss of flexion (bending movements), the loss of extension (straightening movements), and rotational movements in the knee and subsequently loss of muscle strength and flexibility. Postoperatively, fibrosis is a leading cause for joint stiffness, contractures, fusion, pain and also cause for revision surgery and or joint manipulation to reestablish normal joint range of motion and function of the knee. How to manage fibrosis and promote functional range of motion and strength in chronic knee and postoperative knee patients, resides in how early we move, at what speed and degree we move and how much tension and intensity we subject the knee to activate voluntary muscle contraction without aggravation?

In the United States alone, over 687,000 total knee arthroplasties are performed annually and the need for joint replacement is projected to rise dramatically to 3.48 million, and with rise in cost projected to reach $3.0 billion by 2015 if not contained in the near term. There is thus a need for knee rehabilitation device technologies to curb the rise in cost to meet the current and future demands, while affording convenience of use, safety, flexibility, and cost-effectiveness. The increasing need for rehabilitation particularly due to increased joint replacement surgeries will continue to support the demand for innovative and cost effective, patient centered and self-operated rehabilitation technologies to meet current demands for effective and efficient modalities to deliver quality care and contain cost throughout the continuum of the patient care and particularly during the rehabilitation phase of management. While TKA is proven to add value, quality of life and function in patients that underwent the procedure as compared to other less invasive knee surgeries, functional performance post operatively declines precipitously by up to 88% in the first month of TKA, with slower walking speed, stair-climbing speed and limitations in functional activities due to quadriceps muscle weakness, pain, joint stiffness and decreased active and passive range of motion. While traditional physical therapy helps in restoring functional independence, the intensity and duration of rehabilitation due to multitude of factors is usually not matched adequately to counter the rate of muscle weakness and joint stiffness in patients with knee conditions pre and post operatively. Thus, newer models and rehab paradigms to manage the post operative knee is needed to counter post operative debilitative effects on the knee and the rise in overall cost.

The industry of biomedical-rehabilitation and exercise includes many inventions that over the years have continued to be improved to offer increase in effectiveness in the treatment of injured and post surgical patients. Many of the current in-home mechanical therapy devices are complex to operate, involve numerous parts, or have limited effectiveness lacking specificity to be effective. These devices may require the patient to actuate levers, stabilize components, or perform other functions while attempting to stretch his or her knee joint, which may be a painful process with a significant learning curve, and not particularly easy, interesting and motivating to older adults for whom it is designed. Moreover, many of the in-home mechanical devices are not designed to move the knee joint in both flexion and extension and be operational in the active and resisted modes required for muscle activation following a traumatized injury to the knee or subsequent to post operative muscle weakness and joint stiffness. The use and storage of two separate devices to treat joint stiffness can be cumbersome making this invention, which is sized moderately, for placement on the bed and on the floor in sitting, light weight for older adults to move around, technologically easy to operate and flexible particularly interesting and critical in the rehabilitation of the knee.

To save on cost and improve compliance of use, there is need for an improved device that brings the clinic to the patient at all settings, before and after a procedure, to allow for gradual progress of individualized rehab exercises with a single device at the disposal of the patient and their health care provider, affording the patient convenience, safety, independence and total flexibility to drive down cost as they rehabilitate their knee to independence.

### SUMMARY OF THE INVENTION

One object of the present invention is to provide a device and a method for total knee rehabilitation that is cost effective, and can be used independently by a patient in a self-paced manner, and having the flexibility to accomplish knee joint mobility, muscle flexibility, and restore strength and functioning of the injured knee, both pre and post operatively.

Another object of the present invention is to provide a device to comprehensively addresses all aspects of knee rehabilitation need to ensure restoration of range of motion (ROM), joint stiffness, proprioception, muscle strength, endurance and pain modulation; augmenting muscle activation through built in electrical stimulation; restoration of function through motions in passive, active, and/or resistive modes, and operable both in supine and sitting positions.

Another object of the present invention is to provide a safe closed chain, isokinetic exerciser for the pre and post surgical knee patient to promote and ensure mobility for increased joint flexibility, muscle activation, and alleviation of pain post-operatively. The device can be used for post total knee replacement patients as well as for the post anterior/posterior cruciate ligament repaired patient, torn medial and lateral collateral ligaments, torn meniscus, arthritic and debilitated knees; configured to promote early muscle activation, joint flexibility, reduced joint effusion and pain.

Yet another object of the invention is to provide a dynamic knee rehabilitation device capable of stimulating the quadriceps muscle, ranging the joint passively, actively, and provides progressive resistance during exercises at several phases of resistance.

Yet another object of the invention is to provide a safe knee rehabilitation device that is capable of supporting cryotherapy before, during and after exercises, provide accurate measurement of the knee angle in degrees and stimulate muscles using micro-current technology to activate voluntary contraction in weakened muscle spindle, and promote early motor activity for movement. Patients have the option of use for exercising both in supine and in sitting positions pre and post-operatively. The present invention is geared towards providing support throughout the healing phases of the knee, acutely, sub acutely and at advance phases of rehab with assurance of comfort, confidence, and early mobility post-operatively under supervision of a therapist or medical provider with the patient in control of device, independently.

One embodiment of the invention is a device for increasing the range of motion of a patient's knee joint comprising a longitudinal track frame connected at one end to a sitting platform having a thigh lifter, and at the other end to an actuator pivotably connected to a leg and foot platform wherein the actuator generates a translational force that causes the leg and foot platform to move reciprocally along the track frame in a manner that allows motion of the patient's knee joint in a passive, active, or resistive mode.

In another embodiment of the invention, the device comprises input sensors, at least one input/output user interface, and an electronic controller which controls the actuator according to predetermined input parameters.

In another embodiment of the invention, the actuator comprises an electric motor having variable resistance pivotably coupled to the leg and foot platform via a belt driven carriage wherein the electric motor drives at least one pulley connected to the carriage via a belt and wherein an electronic controller controls the variable resistance mechanism of the stepper motor.

In another embodiment of the invention, the actuator comprises an electronically controlled electromagnetic brake for providing variable resistance in a flexion or extension motion, wherein the electromagnetic brake is pivotably coupled to the leg and foot platform via a belt driven carriage wherein the electromagnetic brake comprises an output gear for driving at least one other gear of a driving pulley connected to the carriage via a belt, and wherein an electronic controller controls the variable resistance mechanism.

In another embodiment of the invention, the electronic controller can direct the variable resistance mechanism so that the resistance can be controlled instantly and sequentially, and wherein the user can select from pre-programmed resistance levels or knee angle parameters or can manually adjust the resistance of the flexion or extension motions and wherein the resistance can be programmed to change within a singe flexion and extension cycle or to change over a plurality of cycles.

In another embodiment of the invention, a means for recording, storing and retrieving a user's rehabilitation report via a microprocessor or a computer is provided, wherein the report can be sent to a second central computer where the rehabilitation report can be further analyzed.

In yet another embodiment of the invention, the actuator comprises an electronically controlled electric motor having variable resistance pivotably coupled to the leg and foot platform via a power screw wherein the electric motor drives the carriage linearly along the power screw.

This invention also provides a method for increasing the range of motion of a patient's knee joint using the device of the present invention comprising in one embodiment, positioning a patient in a supine or sitting position on the longitudinal track frame connected at one end to a seat or sitting platform and a thigh lifter, and at the other end to an actuator having variable resistance pivotably connected to a leg and foot platform wherein the actuator generates a translational force that causes the leg and foot platform to move reciprocally along the track frame in a manner that allows motion of the patient's knee joint in a passive, active, or resistive mode.

In another embodiment of the invention, the method involves using a device comprising input sensors, an input/output user interface, and an electronic controller which controls the actuator according to predetermined input parameters.

In another embodiment of the invention, the method involves using a device wherein the actuator comprises an electronically controlled electric motor pivotably coupled to the leg and foot platform via a belt driven carriage wherein the electric motor drives at least one pulley connected to the carriage via a belt.

In yet another embodiment of the invention, the method involves using a device wherein the actuator comprises an electric stepper motor having variable resistance pivotably coupled to the leg and foot platform via a power screw wherein the electric motor drives the carriage linearly along the power screw.

In yet another embodiment, the method of the invention provides a device for passive movement of the knee in supine and in sitting positions through a leg and foot platform, wherein the patient drives the foot toward the anatomical axis of the lower limb in the direction of knee flexion and extension, while being provided support and movement, up or down at the thigh by means of a thigh lifter to aide movement of the lower leg in the horizontal plane, parallel to the base of the track frame thus creating movement in flexion and extension, promoting an increase vascular flow for subsequent healing of traumatized and post operative soft tissues, decreasing joint swelling, stiffness and pain while increasing muscle strength, endurance and knee function.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic of a device and a patient's leg in accordance with one embodiment of the invention.

FIG. 2 is a close up perspective view of schematic of the device of FIG. 1 with the track frame and the motor housing uncovered.

FIG. 3 is a close up perspective view of the seating platform end of the device of FIG. 2.

FIG. 4 is a perspective view of the front end of the seating platform in accordance with one embodiment of the present invention.

FIG. 5 is a close up perspective view of the front end of the seating platform of FIG. 4.

FIG. 6 is a perspective view of the belt driven leg and foot platform carriage in accordance with one embodiment of the present invention.

FIG. 7 is another view of one embodiment of the rear and top portions of the seating platform in accordance with one embodiment of the present invention.

FIG. 8 is a close up perspective view of the motor housing end of a device in accordance with one embodiment of the invention.

FIG. 9 is another perspective view of a stepper motor and gear arrangement in accordance with one embodiment of the invention.

FIG. 10 is a schematic of the user interface in accordance with one embodiment of the invention.

FIG. 11 is a schematic of a device and a patient's leg seated on a chair.

FIG. 12 is a schematic of a device of the present invention and a patient's leg wherein the leg and foot platform is driven by a power screw.

FIG. 13 is a close up view of the motor and power screw arrangement of FIG. 12.

FIG. 14 is an illustration of an embodiment of a drive mechanism showing the use of a variable resistance electromagnetic brake system.

### DETAILED DESCRIPTION OF THE PREFERRED EMBODIMENTS

Detailed descriptions of the preferred embodiments are provided herein. It is to be understood, however, that the present invention may be embodied in various other forms. Therefore, specific details disclosed herein are not to be interpreted as limiting, but rather as a basis for the claims and as a representative basis for teaching one skilled in the art to employ the present invention in virtually any appropriately detailed system, structure or manner.

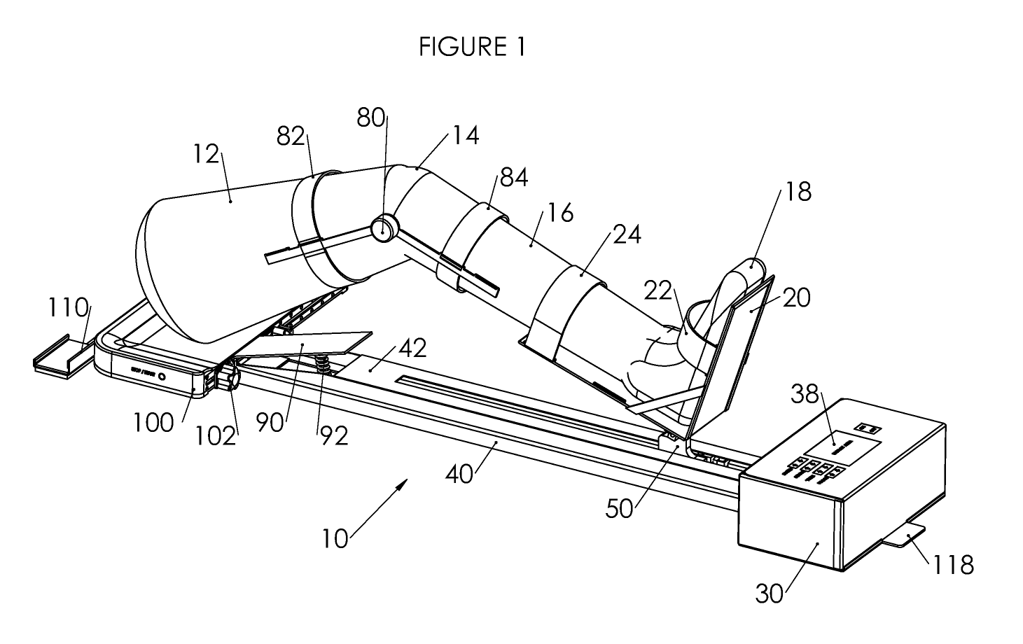

FIGS. 1-3 show one embodiment of a device 10 for increasing the range of motion of a knee joint 14 of a patient's limb comprising a thigh 12, a leg 16 and a foot 18. The device 10 generally comprises a longitudinal track frame 40 having on one end, a sitting platform 100, a thigh lifter or thigh support platform 90, and at the other end, an actuator housing 30, having an actuator 32 coupled to a carriage 50 which is pivotally coupled to a lower leg and foot platform 20. As will be described in detail below, the actuator generates a translational force that moves the carriage along the longitudinal track frame 40 causing extension and/or flexion of the knee joint 14.

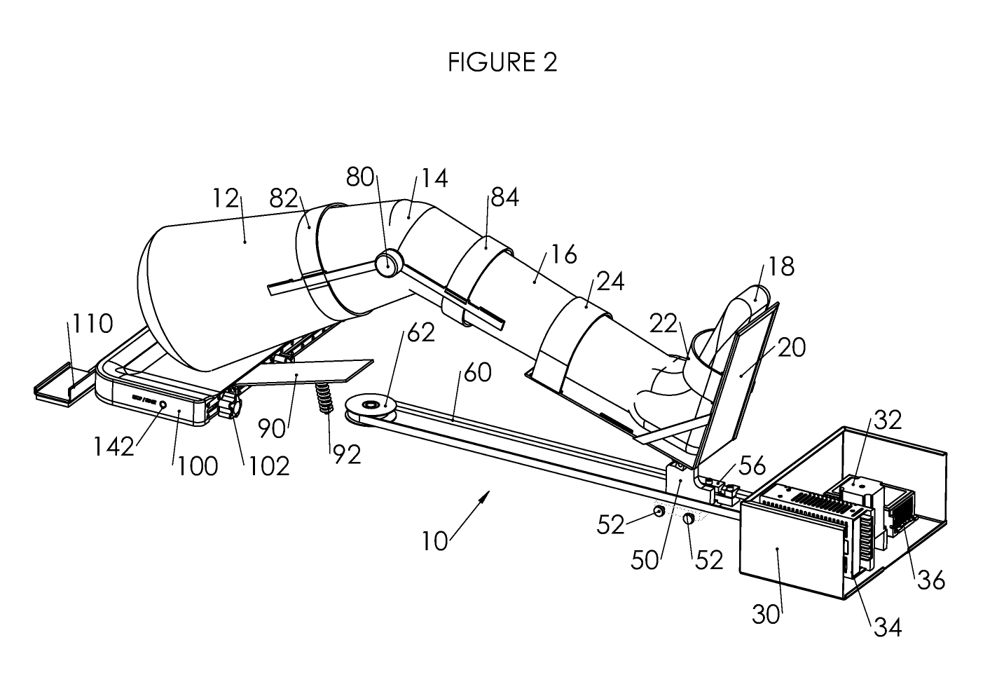

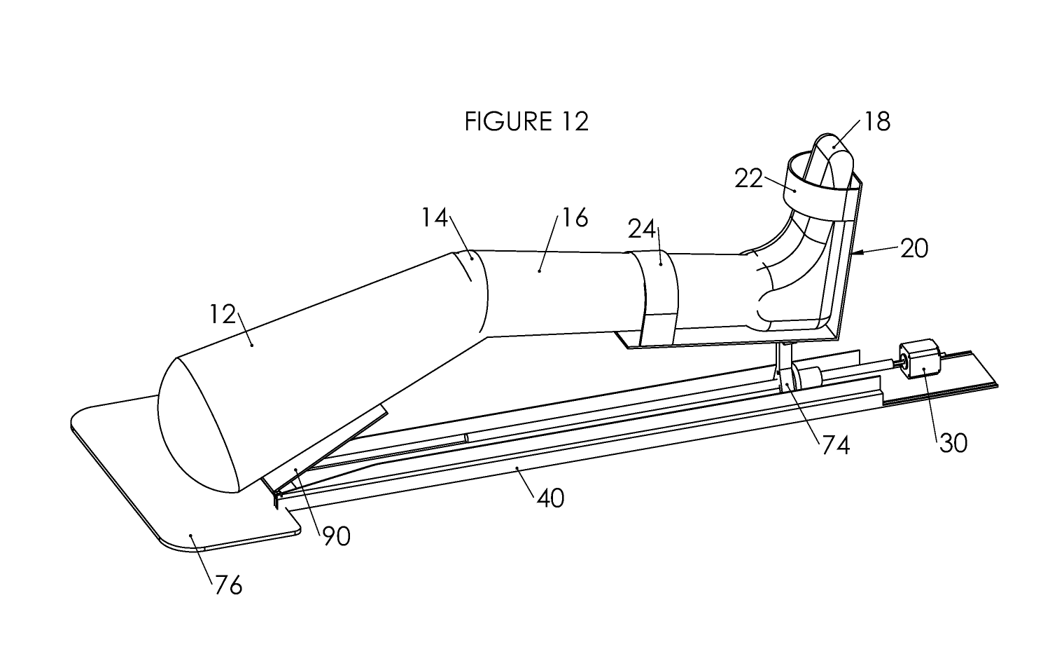

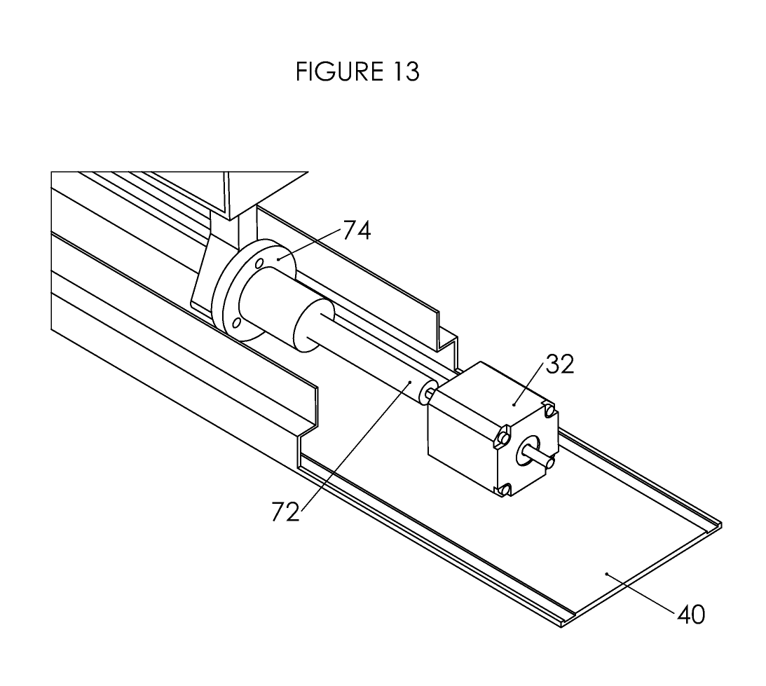

In the illustrative embodiments of FIGS. 1-3 of a device 10, the longitudinal track frame 40 includes a track cover 42 for covering a drive means for moving the carriage 40 pivotally anchored to the movable foot and ankle platform 20 along the track frame 40. As shown in FIGS. 2, 8, and 9, one embodiment of the drive means comprises a drive belt 60, a drive pulley 64, a return pulley 62, a pulley gear 66 and a motor gear 68 driven by a motor 32. Another embodiment of the drive means is shown in FIGS. 12 and 13 and it includes a drive screw 72. By driving the foot and ankle platform 20 by being moved back (heel slide) and forth (foot slide) on the track, the drive means allows the heels to be pushed towards the body or away from it causing the knee joint to flex and extend.

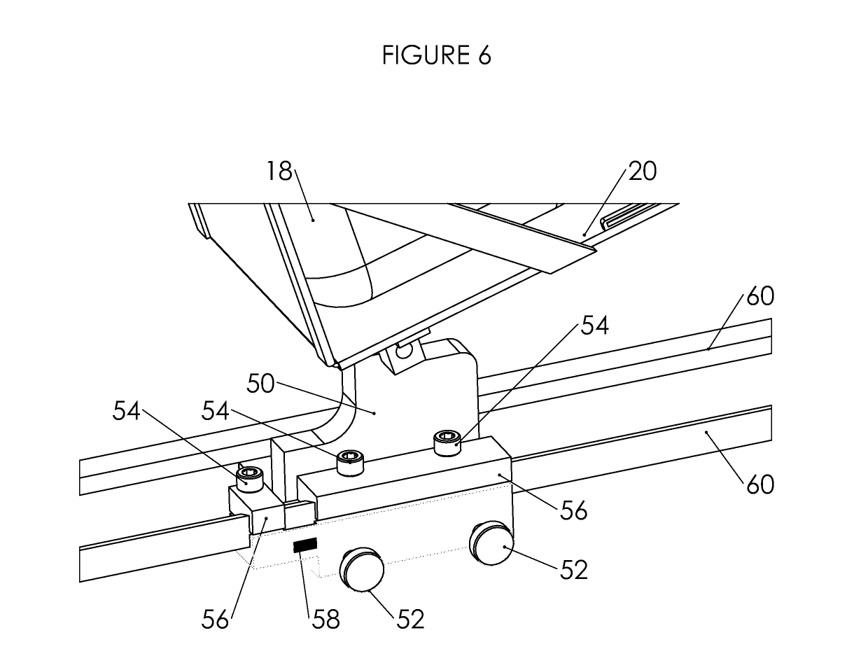

The foot and ankle platform 20 is preferably an L-shaped construct for cradling the foot 18 and the ankle area of the leg 16. The platform 20 may further comprise a support bracket joining the foot and ankle portions of the platform 20, a foot strap 22, and a lower leg strap 24. A foot and ankle carriage member 20, as shown in FIG. 6, is coupled to the drive means and configured to have resistance and allow motion of the platform 20 along the track 40. The carriage 50 is constructed to allow movement of the platform 20 at varying degrees of freedoms preferably between 0 degrees and 120 degrees of range of motion to allow for static and dynamic knee exercises in a passive, active, or resistive mode thereby bending and strengthening the knee at any of the prescribed angles. The axis of movement follows the anatomic axis of the hip, knee and ankle joints.

As shown in FIGS. 6 & 9, the carriage 50 comprises the track rollers 52, the belt clamp 56, the belt clamp bolts 54, for drivably engaging the drive belt 60 through the drive pulley 62 and the drive pulley 64 which is coupled by means of pulley gear 66 to the motor gear 68 of the motor 32. Preferably the carriage 50 pivots off the foot portion of the platform 20. Another embodiment of the carriage is shown in member 74 of FIGS. 12 & 9 and illustrates one embodiment of the device where a threaded carriage 74 is driven by a power screw 72 drivably coupled to a motor 32.

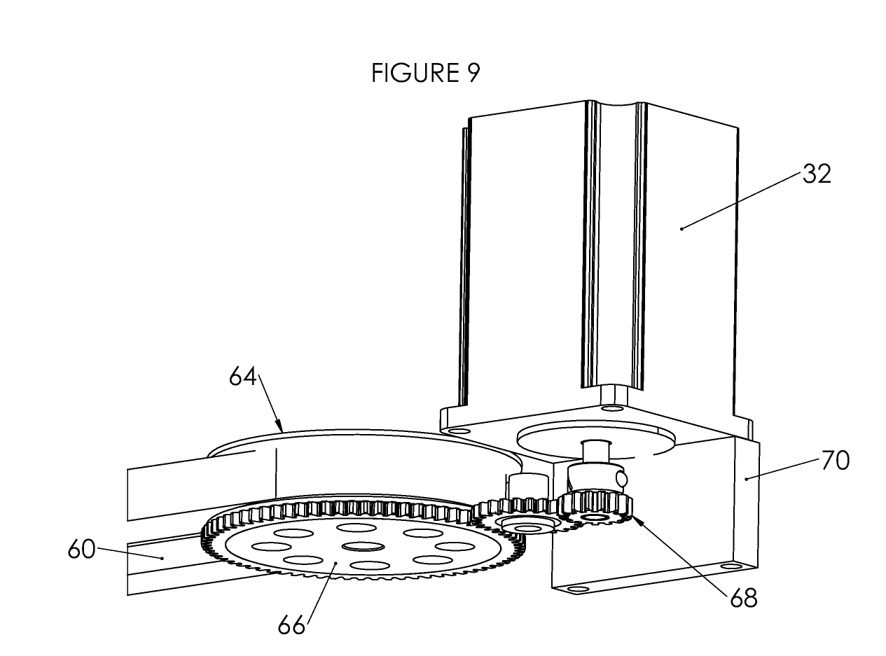

Preferably the motor 32 in FIG. 2 is electronically controlled and the electronic controller 36, the power supply 34, the user interface 38, and the power supply 34 are housed in the motor housing 30 in one embodiment as shown in FIG. 2. The motor 32 can be in the form of a DC or stepper motor. In the embodiment of FIG. 2, the motor 32 drives a drive pulley 64. In the embodiment of FIG. 13, the motor 32 is drivably coupled to a power screw 72. As shown in FIG. 9, the motor 32 is mounted in the housing via a motor mount 70 and comprises the motor gear 68 for engaging the gears 66 on the drive pulley 64 which contains a groove for passage of the drive belt 60. When operated by the electronic controller 36, the motor 32 generates a translational input that causes the leg and foot platform 20 to move towards the patient's body along the track frame thereby stretching the patient's knee joint 14 in a desired direction.

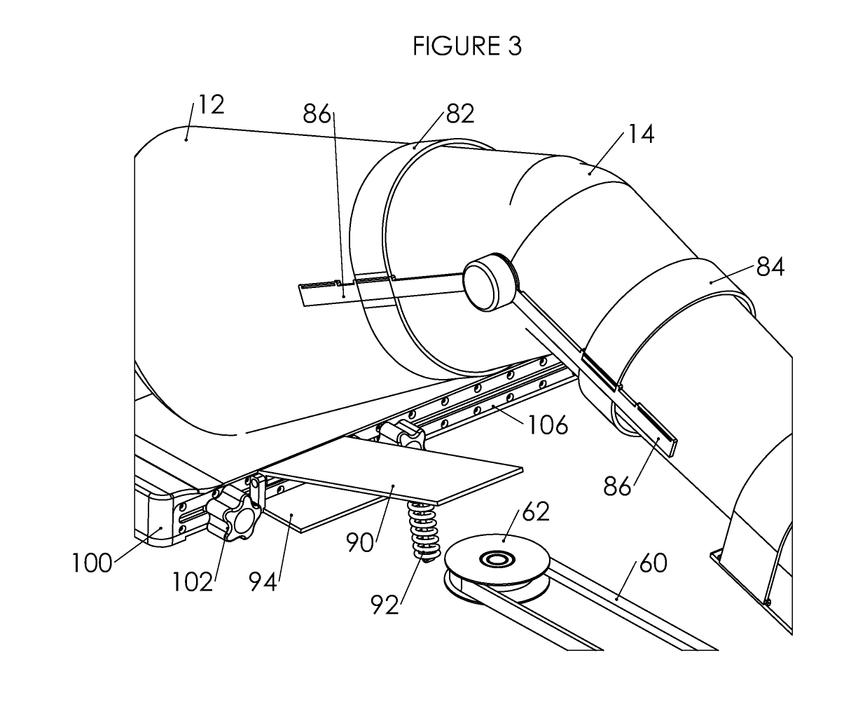

The electronic controller 36 of the motor 32 controls the motor in accordance with user specified parameters. The device 10 can contain any number of input sensors for directing input signals to the controller 36. Preferably, the controller 36 controls the speed, angle, and resistance (force) of the carriage 50. A strain gauge 58 as shown in FIG. 6 may be mounted adjacent the carriage 50 to transmit the force on the carriage 50 by way of electrical resistance signals to the controller 36. Also mounted around the knee joint 14 is an angle sensor 80 having a pair of arms 86 and mounted adjacent the knee joint 16 by a calf strap 84 and a thigh strap 82. See FIG. 3. The input sensors may be wired or wireless. Preferably the input sensors transmit signals to the controller via wireless means.

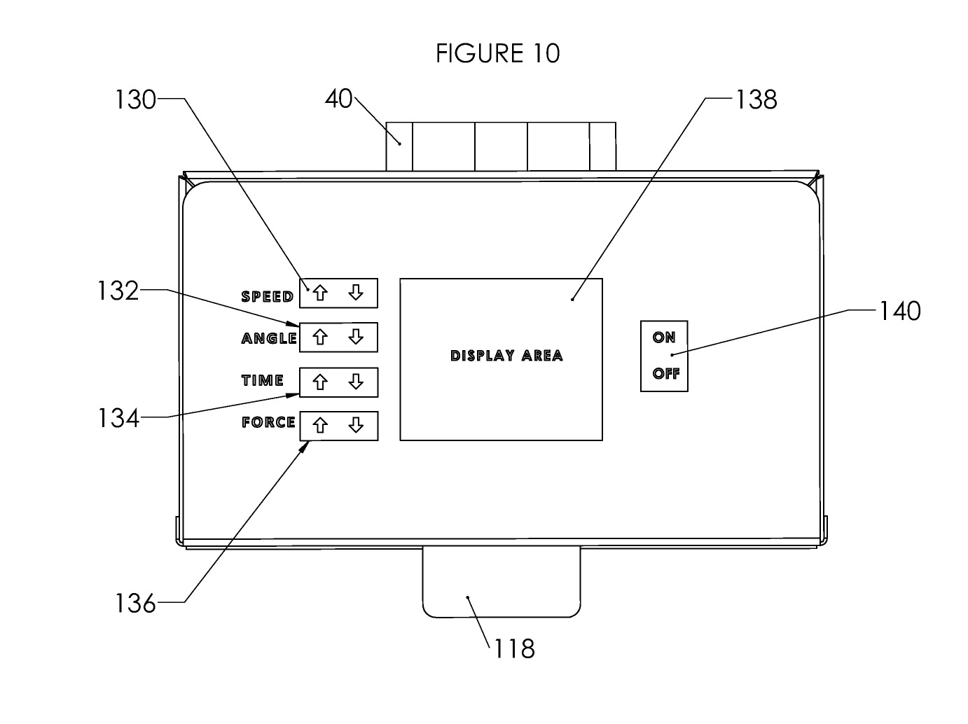

As shown in FIG. 10, the motor housing 30 further comprises a user interface. In one embodiment, the user interface comprises a display area 138, an on/off switch 140, a means for adjusting the speed 130 of the motor, adjusting the angle 132 on the knee joint, adjusting the time 134 of operation, and adjusting the force 136 on the carriage 50.

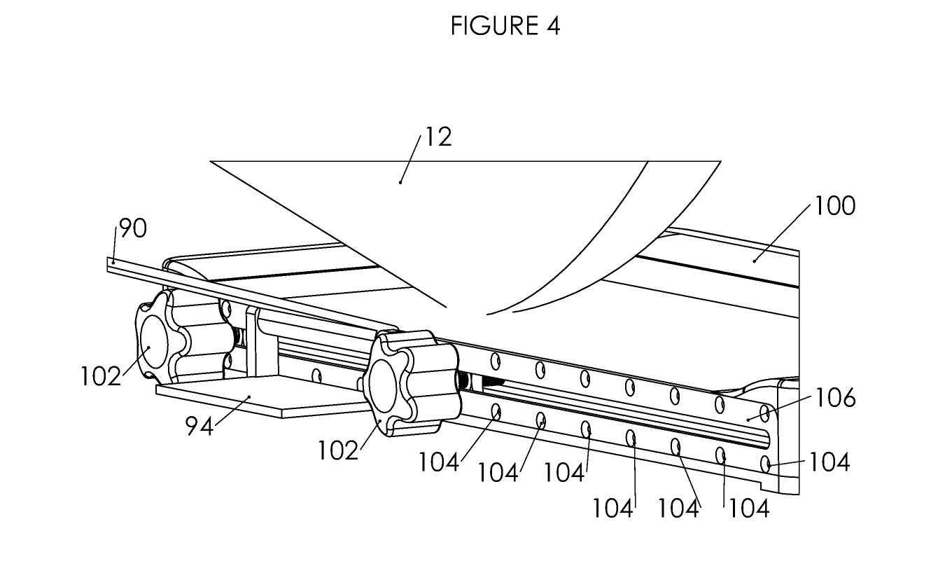

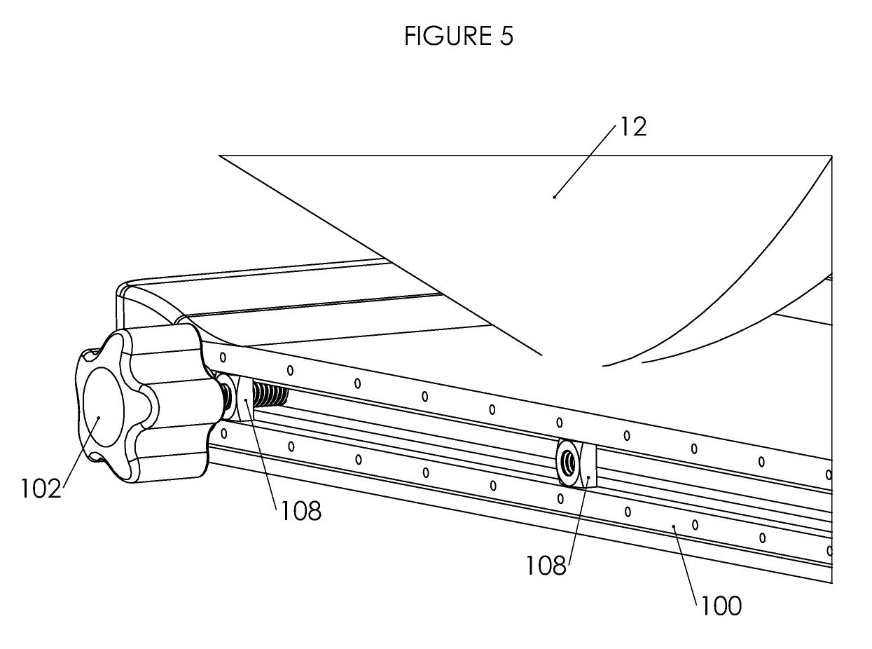

As shown in FIGS. 3, 4, 5 and 7, opposite the motor housing end of the longitudinal track/frame 40 is an adjustable sitting platform 100 comprising a pair of adjuster knobs 102 mounted on opposite sides of a thigh lifter 90 preferably via adjuster nuts 108 as shown in FIG. 5. Adjustment is accomplished by releasing the adjuster knobs 102 and sliding the platform 100 along the adjuster plate 106 having a series of adjuster screws 104 as shown in FIG. 4. Another embodiment of the sitting platform may be configured with a detachable or integral back support member for supporting the user's back while sitting on the platform 100.

As shown in FIG. 4, the sitting platform 100 further comprises a means for cradling and supporting the thigh. In a preferred embodiment, the means comprises a thigh lifter 90 hingedly connected to the sitting platform 100 and having a pivot plate 94 to provide further support for the thigh lifter 90. FIGS. 2 and 3 further illustrate the operations of the thigh lift 90 which lift is accomplished by means of a lifter 92 shown in the figures in the form of a compression spring. Other means known in the art can be used to lift the thigh lift 90, including a piston and cylinder arrangement. A spring hinge arrangement, a torsion spring, or spring plates can also be used to design the thigh lifter. The thigh lifter is configured to support and lift the patient's thigh in a manner that allows motion of the patient's knee joint. FIG. 12 illustrates another version of the sitting platform 76 and thigh lifter 90.

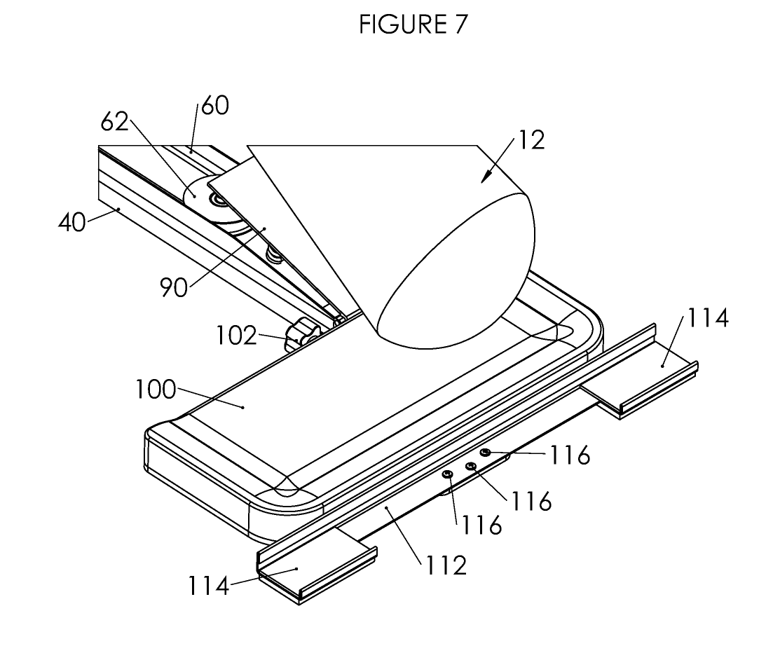

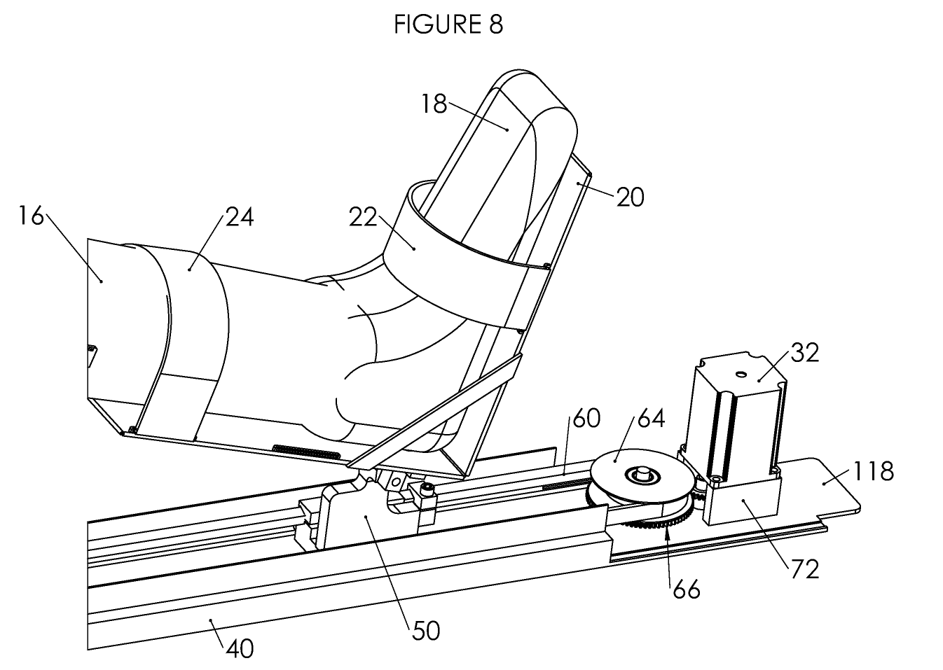

As shown in FIG. 7, connected to the back of the sitting platform 100 is a removable rear stabilizer 110 mounted on the platform via the attachments 116 and comprising a stabilizer bar 112, and a pair of stabilizer/chair leg pads 114. The rear stabilizer complements the front stabilizer tab 118 mounted on the motor housing 30. See FIG. 8.

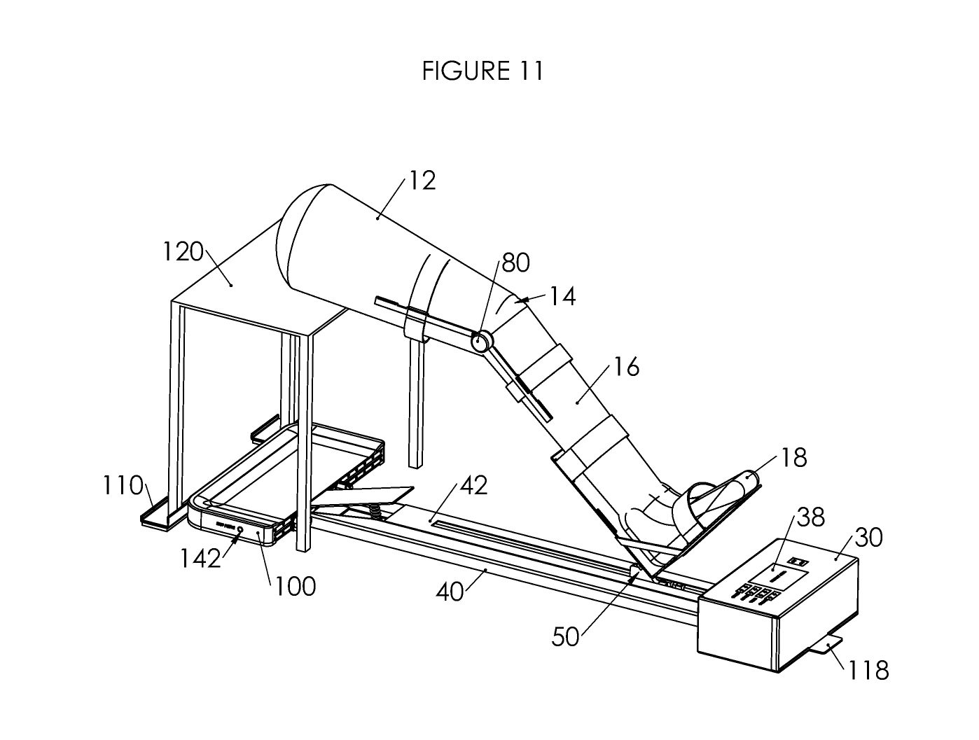

The use of the sitting platform 100 is optional. As shown in FIG. 11, a user may opt to sit on a chair 120 instead of the sitting platform 100. Among the safety or convenience futures of the device is an additional on/off switch 142 mounted on the sitting platform. Also, not shown is an optional wired or preferably remote wireless hand held user interface for inputing speed, angle, time, force and other requirements, having the ability to control the device in the on/or off positions directly on the hand held interface. It is understood that any of the technologies used in fabricating electronic remote controls may be used to operate the device both in the analog and digital remote control interface version of this invention through use of cord or Bluetooth technologies.

Prior to use, it is preferred that the device is set up and calibrated for the specific patient. In order to use the device, the patient first sits on the sitting platform 100. The leg is then placed so that the bottom of the foot is flat against the bottom of the platform 20 and the calf is against the back of the platform 20. Straps 22 and 24 are placed around the foot and calf to secure the leg in place. With the foot strapped in, the thigh should now be above the thigh lifter 90. Preferably between 0 and approximately 15 degrees, the thigh lifter 90 helps facilitate bending of the knee in conjunction with the movable platform 20. In one embodiment, the thigh lifter 90 is moved by a spring tension or piston force that pushes the thigh plate up and pivots where the plate meets the support plate 94.

Preferably, during the first stage of recovery the patient will be using the device in the passive mode wherein the device moves the leg without assistance from the patient in order to achieve an increase in range of motion (ROM), and to decrease scar tissue buildup as the knee is moved in the active and passive modes of flexion and extension. The device bends the knee by moving the foot in a “heel slide” motion, towards and away from the patient. As the foot slides back, the leg and foot platform 20 pivots and the angle of the leg and foot platform 20 is recorded by the angle sensor 80 in order to track the progress of the knee bending.

The electronic controller determines how fast the motor should travel, the angle limits, force parameters and duration (when to stop) based on the current user settings. The range and movement modalities will change as the patient heals and recovers passive and active range of motion, and strength within tolerable pain limits.

The device can also be used not only in the supine position but also in the sitting position. The electronic controller 36 is preferably configured to accept inputs based on the mode of use. Thus, if the user select a different setting (“sitting”) and the device will then know that the user is using the device in a different manner. The operation of the device will be the exact same, except that the leg and foot platform 20 will move at a different pace and will operate in a different range of motion.

When the patient has begun recovering, they will be instructed to start using their muscles to move their foot in the heel slide motion in the passive mode, and then in the active and finally in the resistive mode of operation. The setting on the device will be changed and recalibrated such that the foot slide mechanism will move, assist or provide resistance to the moving leg, and will move the leg on its own depending on the selected mode of use. A preset force allowance is created, and when the device recognizes that the patient is putting too much force on the system, it will move the leg and foot platform 20 accordingly to relieve the stress. This will ensure patient safety from placing too much stress on their newly operated knee. Also, the motor will move the platform at a consistent pace in the passive mode regardless of patient input, in order to progressively facilitate increase ROM and allow patient activation of the knee muscles to maintain ROM and consistent with their stage of healing, strength and level of comfort.

Yet a third modality exists in more advanced stages of recovery where the patient will be participating in active and resisted motions. Under this scenario the device will not move until a prescribed amount of force is placed on the foot platform 20 in the direction of travel. This will require the patient to move their leg in the heel slide motion while pushing and pulling on a certain amount of “weight/force”, against the resistance offered by the device, thus creating a tension force to activate maximum muscle contraction of the knee muscles.

These different modalities—passive, active, resistive can be used while in supine or sitting positions.

F. Joutras et al, in U.S. Pat. No. 5,954,621, disclose a knee brace type joint having an electronic braking means as resistance element. A controller can adjust the braking force on the joint thereby providing resistance to flexion and extension in a controlled manner. Additionally, M. Anjanappa, in his U.S. Pat. No. 5,583,403, discloses an apparatus for use with exercise machines to achieve programmable variable resistance. The machine includes a motor and an attached magnetic clutch.

In another embodiment, resistance is provided by a stepper motor 32 by holding the motor position until the force sensor (strain gauge) indicates to the system that the desired force has been overcome. Once the desired force is achieved the system will step the motor in the forced direction, relieving some of the force. This process is repeated until the user has moved the desired distance.

In one embodiment of the present invention, a resistance element such as an electromagnetic brake 150 provides repeatable and instantly variable resistance.

In another embodiment, a bidirectional variable resistance for extension or flexion can be provided using a magnetic brake mechanism. In one embodiment, the user can select resistance either for extension or flexion for one half of the cycle, and no significant resistance for the other half. The electronic controller controls the electronic brake or other electrically controlled resistance element associated with resistive motion of the foot and ankle platform. The electronic controller can also be designed to adjust resistance at different points along the extension and flexion halves of the rehabilitation cycle to allow for isometric exercise along the continuum of the 0-120 degree ROM cycle of knee motion.

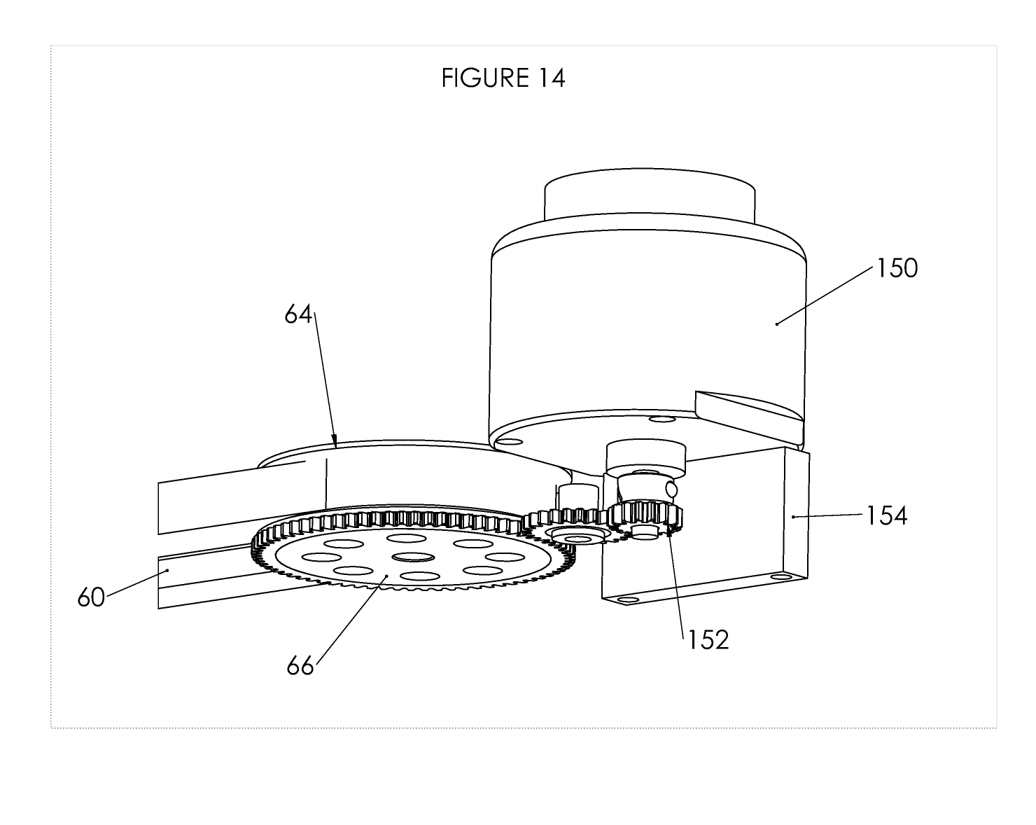

One embodiment of the variable resistance mechanism is provided in the motor housing 30 to include a magnetic brake 150 mounted using the block 154 and connected to the drive pulley 64 via the gears 152. See FIG. 14. The use of gears 152 allow for fast rotation of the brake while maintaining relatively small motions in the heel slide direction of motion. In another embodiment, the magnetic brake 150 may have a pulley attached to the shaft of said brake, optionally, a reducing pulley, a belt joining said brake shaft pulley and said reducing pulley, said shaft pulley connected to the drive pulley 64.

In a preferred embodiment, a micro-processor is integrated into the electronic controller or a personal computer and associated software that is connected to said variable resistance mechanism so that the resistance can be controlled by said microprocessor, wherein said computer or user interface allows the user to select from pre-programmed resistance levels or manually adjust the resistance. An input port such as a RS-232 may be connected to the electronic controller to allow for external control of the device.

In addition to the knee angle sensor and the force sensor or strain gauge, other sensors such as seat position sensor, a thigh lifter pressure sensor, carriage speed sensor, may be used to enhance the safe and efficient operation of the device. It is understood that any sensor used in the art can be incorporated to provide accurate signal parameters to the electronic controller without departing from the creativity of this invention.

In one embodiment of the electronically controlled resistance mechanism, the output shaft from the motor is attached to the drive pulley 64 which is in turn engaged by drive belt 60, with an electromagnetic brake pulley connected by a separate belt to the drive pulley 64 wherein the brake can produce instantaneous varying resistance as directed by a micro-processor inside the electronic controller or externally connected computer and the variable resistance is transferred to the carriage 50 via the drive mechanism.

The variable resistance electromagnetic brake assembly allows for a smooth and gradual increase in resistance during the heel slide or foot slide motion of the foot and ankle platform.

The magnetic brake is a preferred resistance element. Other resistance elements may be used including electromotive, fluid flow restriction or simple mechanical resistance pads. Electrical power is provided to the entire system by standard means such as AC voltage found in homes or gyms, or by rechargeable batteries or the like.

To exit the system, the patient unstraps their leg and exits the machine. It is understood that all the inputs and outputs are run via a microprocessor that can be either internally to the motor housing, a remote controller or an external device such as a laptop, and apps for smart phones/tablets via Bluetooth technology. The history of the rehab can be stored in the computer memory of the micro-processor within the user interface. Rehab results can also be printed out or transferred to a standard storage medium such as compact disk or the like. Additionally, results can be transferred to a central computer which could then integrate data and provide the user with a complete rehab analysis. The patient may change resistance levels during an exercise bout without getting out of the seat of the apparatus. Additionally, the apparatus can easily be adjusted to accommodate a diverse body weight and heights of individuals.

The force applied by the brake is regulated by the electronic control unit, which detects the direction and position of the leg and foot platform 20 or of the knee angle sensor 80 and generates a control signal to the electromagnetic brake.

Preferably, the resistance device such as an electromagnetic brake is located within the motor or control housing 30 wherein electromagnetic brake communicates with drive pulley 64 via a separate brake belt. In another embodiment, the electric motor engages with an electronically controlled slip clutch which in turn engages the drive belt 60. The current apparatus can be programmed to apply resistance to flexion or extension in the initial half of the rehab cycle and to then apply an automatic return force in the other half of the rehab cycle.

As used herein, an electronic controller includes a microprocessor or personal computer and associated software connected to the device remotely or adjacent to the actuator so that different modalities for using the device, including resistance mechanisms can be controlled by said controller.

As an alternate mechanism, instead of a slip clutch supplying the variable force, the DC motor torque, controlled by a microprocessor can be used to supply variable force.

US 2005/0239602 directed to a bidirectional resistance exercise apparatus illustrates various electronic resistance mechanisms and firmware that are easily adaptable to the instant invention. The disclosure of US 2005/0239602 is herein incorporated by reference in its entirety.

When the instant device is used for physical rehabilitation, it is often desirable to limit the overall movement of the leg and foot platform 20. Using a separate setup menu, the user or their trainer can enter the desired start and stop locations. The start position and stop position can be entered as angular values (ROM), or the moveable member can be positioned to the desired point and the position measured by the microprocessor from a standard internal position sensor, not shown. During use, when the moveable member reaches either limit position, the force is increased to a maximum value, stopping any further movement. After a short delay, the force, produced by an internal resistance mechanism housed in the motor housing is reduced, and the moveable member is then allowed to reverse the direction. If the movement direction is not reversed, then the force again increases to maximum, preventing further movement past the limit position. The system can be set at a fixed position in order for the user to perform isometric exercise. The system can be set to provide a fixed time at the locked position. To do this, the user sits on the apparatus and initiates a cycle. After all the predetermined adjustments are made, the user raises his or her leg, and at the predetermined position the moveable member locks. The force during the movement portion can be programmed at an appropriate value, allowing a variety of resistance from minimal to high. After the programmed time duration, the microprocessor indicates to the user that he or she has completed the time and then slowly reduces the locking force allowing the user to freely move his or her legs.

There may be situations where dynamic levels to the holding force of the thigh lifter, or leg length setting might need to be adjusted differently during the extension or flexion half of the cycle. The microprocessor can use the directional information, provided by the knee angle sensor or any one of the adjustment mechanisms described above can be used independently or in any combination with one another.

Preferably, a specially designed knee support wraps as a cold pack and/or electronic stimulation sleeve or hot pack around the knee with electrodes placed at two point's on the anterior knee to induce electro-stimulation muscle contractions.

In terms of examples of user defined parameters, when supine, heel slides: allow for 0-120 degrees: passive and active modes with resistance; short arc quads: at 30 degrees, 45 Degrees, and 60 degrees of knee flexion; device moves between 30 degrees and 60 degrees maximum of extension from flexion, with a total degrees of 90. Exercises: Knee extensions passive, active, and resistive. Resistance: 0 lbs and up to 30 lbs

When sitting, knee and hip at 90-90 degrees; Range of motion will range between 100 degrees of knee flexion and 5 degrees for knee extension to allow for 90 degrees to 0 degrees range of motion.

Speed in both the supine and sitting positions should preferably range between 0 degrees/minute to 120 degrees per minute with maximum speed of 120 degrees/minute for safety operation of equipment.

In terms of method of use for knee rehab, a sample rehab progression would be as follows:

### Week 1 Post-Operative (Day 1-5)

Patient will perform only supine passive knee activities of knee flexion and extension
Range: −10 degrees of knee extension to 90 Degrees. Most patients will be comfortable between −10 degrees knee extension and 70 degrees of passive knee flexion.
Quad sets: Actively pressing the quad in to extension at 0 to -10 degrees of knee extension with or without muscle stimulations 3-5×/day between 10-30 reps, with ice and preferably muscle stimulation×3×/day to the quad muscle.
Heel slides: between 0 degrees of knee extension and 80 degrees, 2-3×/day, 1-2 hours each time. This should be done as a passive movement, progress by adding 1-2 degrees of motion every 24 hours as tolerated.
Short Arc Quads: Knee at 30 degs, Action will be passive extension of the knee from 30 degs of knee flexion to 0-10 degrees of ext, no more than 30 degs arc of motion.

### Days 5-14

### Supine:

Quad sets: 5×10-15 sets with estimate 3-5×/day
Heel slides: 0 degrees of knee extension—90 degrees as tolerated, Passive and active modes
Short Arc Quads (SAQ): @45 degrees: Knee flexion to 0 degrees of knee extension, passive and Active

### 2-4 Weeks

### Supine:

Quad sets: increase sets with muscle stimulation 30 min×3×/day.
Heel Slides: 0-120 degrees, Passive and active and resisted movements. Resistance is gradual 1-10 lbs
SAQ: 45 degrees to 0 degrees, Passive, active and resisted with gradual wt. 0-10 lbs
Sitting: Long Arc Quads (LAQs): knee flexion 90 degrees-to 0 degrees, gradual increase in wt. 0-10 lbs.

### 4-12 Weeks

Heel Slides: 0-120 degrees, passive, Active, and resistive, with resistance of 1-30 lbs
Quad sets with muscle stimulation
SAQs with muscle stimulation @45 degrees of knee flexion with resistance ranging from 5-30 lbs
LAQ with muscle stimulation @90 degrees of knee flexion to 0 degrees of knee extension, resistance 5-30 lbs
Cycling: 30 min/day×2×/day at 1-2 revolutions/sec as tolerated with manual resistance.
This is what the instant device will do but the patient will have other exercises to perform to add to their rehab routine such as, Straight leg raise, hip adduction with a squeeze ball, bridging and hip abductions and stretching of the hamstrings supine, and side lying with and without resistance.
Allowing the device to extend to 5 degrees beyond 0 degrees when the leg is in extension will also stretch the hamstring in the machine and promote end range extension

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims. Documents including patents and non patent references cited herein are expressly incorporated by reference.

What is claimed:

1. A device for increasing the range of motion of a patient's knee joint comprising a longitudinal track frame connected at one end to a sitting platform having a thigh lifter, and at the other end to an actuator pivotably connected to a leg and foot platform wherein the actuator generates a translational force that causes the leg and foot platform to move reciprocally along the track frame in a manner that allows motion of the patient's knee joint in a passive, active, or resistive mode.

2. The device of claim 1, further comprising input sensors, at least one input/output user interface, and an electronic controller which controls the actuator according to predetermined input parameters.

3. The device of claim 2, wherein the input sensors is at least one selected from the group consisting of knee angle sensor; carriage position sensor, thigh lifter pressure sensor, seat position sensor, force sensor, and carriage speed sensor.

4. The device of claim 2, wherein the actuator comprises an electronically controlled electric stepper motor pivotably coupled to the leg and foot platform via a belt driven carriage wherein the electric motor drives at least one pulley connected to the carriage via a belt and wherein an electronic controller controls the variable resistance mechanism of the stepper motor.

5. The device of claim 2, wherein the actuator comprises an electronically controlled electromagnetic brake for providing variable resistance in a flexion or extension motion, wherein the electromagnetic brake is pivotably coupled to the leg and foot platform via a belt driven carriage wherein the electromagnetic brake comprises an output gear for driving at least one other gear of a driving pulley connected to the carriage via a belt, and wherein an electronic controller controls the variable resistance mechanism.

6. The device of claim 5, wherein said electronic controller can direct said variable resistance mechanism so that the resistance can be controlled instantly and sequentially, and wherein the user can select from pre-programmed resistance levels or knee angle parameters or can manually adjust the resistance of the flexion or extension motions.

7. The device of claim 6, wherein the resistance can be programmed to change within a singe flexion and extension cycle or to change over a plurality of cycles.

8. The device of claim 6, comprising a means for recording, storing and retrieving a user's rehabilitation report via a microprocessor or a computer, wherein said report can be sent to a second central computer where the rehabilitation report can be further analyzed.

9. The device of claim 2, wherein the actuator comprises an electronically controlled electric motor pivotably coupled to the leg and foot platform via a power screw wherein the electric motor drives the carriage linearly along the power screw.

10. A method for increasing the range of motion of a patient's knee joint using the device of the present invention comprising, positioning a patient in a supine or sitting position on a longitudinal track frame connected at one end to a seat or sitting platform having a thigh lifter, and at the other end to an actuator having variable resistance pivotably connected to a leg and foot platform wherein the actuator generates a translational force that causes the leg and foot platform to move reciprocally along the track frame in a manner that allows motion of the patient's knee joint in a passive, active, or resistive mode.

11. The method of claim 10 wherein the patient can further adjust the method by inputting parameters via at least one input/output user interface, and wherein an electronic controller controls the actuator according to predetermined input parameters.

12. The method of claim 11, wherein input sensors for sensing input parameters is at least one selected from the group consisting of knee angle sensor; carriage position sensor, thigh lifter pressure sensor, seat position sensor, force sensor, and carriage speed sensor.

13. The method of claim 10, wherein the actuator comprises an electronically controlled electric stepper motor having variable resistance pivotably coupled to the leg and foot platform via a belt driven carriage wherein the electric motor drives at least one pulley connected to the carriage via a belt and wherein an electronic controller controls the variable resistance mechanism of the stepper motor.

14. The method of claim 10, wherein the actuator comprises an electronically controlled electromagnetic brake for providing variable resistance in a flexion or extension motion, wherein the electromagnetic brake is pivotably coupled to the leg and foot platform via a belt driven carriage wherein the electromagnetic brake comprises an output gear for driving at least one other gear of a driving pulley connected to the carriage via a belt, and wherein an electronic controller controls the variable resistance mechanism.

15. The method of claim 14, wherein said electronic controller can direct said variable resistance mechanism so that the resistance can be controlled instantly and sequentially, and wherein the user can select from pre-programmed resistance levels or knee angle parameters or can manually adjust the resistance of the flexion or extension motions.

16. The method of claim 15, wherein the resistance can be programmed to change within a singe flexion and extension cycle or to change over a plurality of cycles.

17. The method of claim 10, comprising a means for recording, storing and retrieving a user's rehabilitation report via a microprocessor or a computer, wherein said report can be sent to a second central computer where the rehabilitation report can be further analyzed.

18. A method for passive movement of the knee in supine and in sitting positions through a leg and foot platform, wherein the patient drives the foot toward the anatomical axis of the lower limb in the direction of knee flexion and extension, while being provided support and movement, up or down at the thigh by means of a thigh lifter to aide movement of the lower leg in the horizontal plane, parallel to the base of the track frame thus creating movement in flexion and extension.
